(19) United States
(12) Patent Application Publication
(10) Pub. No.: US 2007/0021865 A1
(43) Pub. Date: Jan. 25, 2007

(54) Metered ethanol blending fuel pump

(76) Inventor: Tyler J. Albertson, Granite Falls, MN (US)

Correspondence Address: Fagen Engineering, LLC, 501 West Hwy 212, Granite Falls, MN, 56241, US

(21) Appl. No.: 10/967,052

(22) Filed: Dec. 13, 2004

(51) Int. Cl. G06F 17/00

(52) U.S. Cl. 700/231; 44/451

(57) ABSTRACT

The metered ethanol blending fuel pump is a concept based on existing technology providing a feasible method to increase the use of cleaner burning ethanol. With this system, fuel pumps at gas stations would pump a combination of E-85 fuel and regular super unleaded gasoline or no lead gasoline at a ratio specified by the customer. The metered ethanol blending fuel pump would allow blends anywhere in between 10% and 85% ethanol.

A metered ethanol blending fuel pump would blend E-85 fuel ethanol with regular super unleaded gasoline to a percentage selected by the customer. The technology to meter and blend fuel exists today for the use in selecting grades of fuel or octane rating. This technology could be adapted by fuel pump manufacturers to blend the ethanol at higher percentages than it is currently sold. Super unleaded gasoline today is blended with only about 10% ethanol. E-85 on the other hand is 85% ethanol. The metered ethanol blending fuel pump would allow blends anywhere in between 10% and 85% ethanol.

To further automate this system programming in the metered ethanol blending fuel pump could be adapted with help from the automotive industry. Each automobile could be tested or evaluated by the respective manufacturers to determine the optimum percentage of blended ethanol fuel that will combust in their engine and still run efficiently. The vehicle make, model, and year would be within a database at the fuel pump. The consumer would then select his/her vehicle make, model, and year and the metered ethanol blending fuel pump would automatically dispense the proper blend of ethanol and gasoline. A user intervention override could also be used for those consumers that wish to purchase a little higher or a little lower percentage blend of ethanol and gasoline than recommended by the vehicle manufacture. The fuel pump at the gas station could also continue to pump super unleaded or straight E-85 to accommodate customers who do not want the blended fuel.

Virtually all gas stations sell super unleaded gasoline. Several now sell E-85 ethanol fuel. Those stations that sell both types of fuel could easily adapt to using the metered ethanol blending fuel pump. Storage of both products would already be in place, so implementing this system would simply mean modifying the fuel pump and piping to upgrade to this blending system. This system would need to be properly designed, certified, and integrated by current fuel pump dispensing manufacturers.

1. What I claim as my invention is a programmed fuel pump utilizing existing technology to: blend E-85 fuel ethanol with super unleaded or no lead gasoline to a customer specified ratio of ethanol to gasoline for consumption in their motor vehicle. This claim is to include the piping necessary to combine the fuels as well as the computerized programming and displays for user interface and retailer measurement. The actual design of the system is to be achieved by those in the fuel sale industry interested in utilizing this claim.
